(19) United States
(12) Patent Application Publication
(10) Pub. No.: US 2022/0395741 A1
(43) Pub. Date: Dec. 15, 2022

(54) ACTIVITY TRACKING AND FEEDBACK IN REAL-TIME SHARED VIRTUAL REALITY ENVIRONMENT

(71) Applicant: Within Unlimited, Inc., Venice, CA (US)

(72) Inventors: Aaron Koblin, Los Angeles, CA (US); Chris Milk, Los Angeles, CA (US); David Stuart Cowling, Santa Monica, CA (US)

(73) Assignee: Within Unlimited, Inc., Venice, CA (US)

(21) Appl. No.: 17/774,754

(22) PCT Filed: Oct. 23, 2020
(86) PCT No.: PCT/IB2020/060001

§ 371 Date: May 5, 2022

Related U.S. Application Data
(60) Provisional application No. 62/937,360, filed on Nov. 19, 2019.

(51) Int. Cl. A63B 71/06; G02B 27/01; A63B 24/00

(52) U.S. Cl. CPC A63B 71/0622; G02B 27/017; A63B 24/0062; A63B 24/0075; A63B 2071/0675; A63B 2071/0638; A63B 2220/803; A63B 2214/00

(57) ABSTRACT

A computer-implemented method includes running a training program for a user wearing a virtual reality (VR) headset; and, while running the training program: monitoring activity of the user; presenting video images in a display of the VR headset corresponding to the activity of the user; and based on said monitoring, modifying at least one aspect of said training program.

### RELATED APPLICATIONS

This application claims the benefit of U.S. Provisional Application No. 62/937,360, filed Nov. 19, 2019, the entire contents of which are hereby fully incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to virtual reality (VR), and, more particularly, to methods, systems and devices supporting activity tracking and feedback in a real-time shared VR environments.

### BACKGROUND

People exercise and play sports for fun and to get and stay fit and to maintain good health and wellbeing.

Virtual and augmented reality devices allow a user to view and interact with virtual environments. A user may, effectively, immerse themselves in a non-real environment and interact with that environment. For example, a user may interact (e.g., play a game) in a virtual environment, where the user's real-world movements are translated to acts in the virtual world. Thus, e.g., a user may simulate tennis play or bike riding or the like in a virtual environment by their real-world movements.

A user may see a view of their virtual environment with a wearable VR/AR device such as a VR headset or AR glasses or the like (generally referred to as a head-mounted display (HMD)). A representation of the VR user (e.g., an avatar) may be shown in the virtual environment to correspond to the VR user's location and/or movements.

People often benefit from feedback and progress review and analysis when the perform activities such as exercise or the like. Some non-VR systems may allow users to use physiological sensors (e.g., heart-rate monitors, or the like) and may provide summary or even real-time information about a user's physiology while the user is exercising. Some systems may also provide information about equipment being used by a user. For example, the Peleton bike system may provide a user with information about their exercise duration, equipment usage (e.g., cycling cadence), and even some physiological information (e.g., heart rate). Notably, the information being provide by the Peleton and similar systems is information about the stationary user equipment (e.g., based on rotations of a bike's wheels), but is not information about the user's actual movements.

Furthermore, such system do not provide real-time feedback that will help a user improve for a particular activity or their physical wellbeing. Generally, for VR/AR users, it has been difficult to provide such feedback, other than for factors such as duration of exercise and some physiological measurements (for paired devices such as heart-rate monitors or the like).

In addition, users of VR-based activities (games, sports, exercise, etc.) generally pick their routine and difficulty level, and then perform their activity (the selected routine at the selected difficulty level). For example, a user may play a particular VR-based game (which requires a lot of movement of the user's body and limbs). The user selects the game they wish to play and a play level and then plays. If the game is too difficult, the user may select an easier level for future play, and if the user found the game to be too easy, the user may select a more difficult level for future play. However, the user has to make these decisions themselves, and based on their perceived level of difficulty. The user may have no way of comparing themselves to other users or to know what they could achieve. In a comparable real-world situation, a good personal trainer or coach may give a user guidance and direction, both as to difficulty levels and form. But in the VR/AR world, the user has no such guidance.

It is desirable, and an object of this invention, to provide users of VR/AR-based activities with feedback and guidance based on their real-world movements and how those movements correspond to a virtual world activity.

It is further desirable, and a further object of this invention, to modify the VR/AR-based activities of a user activity based on their current VR/AR-based activity and on factors such as expected or desired activity levels and/or achievements.

It is further desirable, and a further object of this invention, to provide a virtual and real-time coaching or guidance to users performing VR/AR activities.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method including (a) running a training program for a user wearing a virtual reality (VR) headset. The method also includes: (b) while running the training program: (b)(1) monitoring activity of the user; (b)(2) presenting video images in a display of the VR headset corresponding to the activity of the user; and (b)(3) based on the monitoring in (b)(1), modifying at least one aspect of the training program. Other embodiments of this aspect include corresponding computer systems, apparatus, and computer programs recorded on one or more computer storage devices, each configured to perform the actions of the methods.

Implementations may include one or more of the following features, alone or in combination(s):
The method where the modifying in (b)(3) occurs in real time; and/or
The method where the modifying in (b)(3) is based on one or more of: (a) a comparison of the activity of the user to expected or desired activity of the user; and/or (b) physiological data of the user; and/or (c) goals or targets set by or for the user; and/or (d) a score achieved by the user during the training program; and/or (e) a level achieved by the user during the training program; and/or (f) prior activities of the user; and/or
The method where the modifying of the training program in (b)(3) dynamically adjusts a level of difficultly of the training program; and/or
The method where the training program has multiple levels, and where the user is at a particular level of the multiple levels, and where modifying of the training program in (b)(3) changes the user to a different level; and/or
The method where the training program has a duration, and where modifying of the training program in (b)(3) changes the duration; and/or
The method where the training program may include multiple parts, and where modifying of the training program in (b)(3) changes a current part or an order of the parts; and/or
The method where the at least one training program modification was determined by the remote system based on the movement data; and then, (b)(7) based on the at least one training program modification received in (b)(6), modifying a second at least one aspect of the training program; and/or
The method where the movement data are determined, at least in part, by the VR headset; and/or
The method where the VR headset provides the movement data to the remote system in (e) via a distributed network; and/or
The method where the modifying of the training program in (b)(7) dynamically adjusts a level of difficultly of the training program; and/or
The method where the training program has multiple levels, and where the user is at a particular level of the multiple levels, and where modifying of the training program in (b)(7) changes the user to a different level; and/or
The method where the training program has a duration, and where modifying of the training program in (b)(7) changes the duration; and/or
The method where the training program may include multiple parts, and where modifying of the training program in (b)(7) changes a current part or an order of the parts; and/or
The method where the at least one training program modification was determined by the remote system based on one or more of: (i) a comparison of at least some of the movement data to expected and/or desired movements of the user; and/or (ii) physiological data of the user, where the physiological data was provided to the remote system by the VR headset; and/or (iii) goals or targets set for the user; and/or (iv) data about one or more prior activities of the user; and/or
The method where the data about one or more prior activities of the user may include: prior movement data of the user and/or prior training programs or activities of the user.

Implementations of the described techniques may include hardware, a method or process, or computer software on a computer-accessible medium.

Another general aspect includes a computer-implemented method that includes (a) providing a training routine to a virtual reality (VR) headset, where the training routine may include one or more user activities; and (b) obtaining data from the VR headset; and (c) based on the data, determining at least one training program modification for the training routine. The method also includes (d) providing the at least one training program modification to the VR headset. Other embodiments of this aspect include corresponding computer systems, apparatus, and computer programs recorded on one or more computer storage devices, each configured to perform the actions of the methods.

Implementations may include one or more of the following features, alone or in combination(s):
The method where the data obtained in (b) includes movement data corresponding to movement of a user wearing the VR headset, and where the user is performing an activity; and/or
The method where the determining in (c) is based, at least in part, on whether movement of the user corresponds to expected or desired movements of the user for the activity; and/or
The method where the determining in (c) is based, at least in part, on physiological data of the user; and/or
The method where the physiological data are obtained from the VR headset; and/or
The method where the at least one training program modification was also determined in (c) based on goals or targets set for the user; and/or
The method where the at least one training program modification was also determined in (c) based on prior data about the user; and/or
The method where the prior data about the user may include: prior movement data of the user and/or prior training programs or activities of the user; and/or
The method where the training routine produces a user score, and the at least one training program modification was also determined in (c) based on the user score; and/or
The method where the training routine has multiple levels, and where the user is at a particular level of the multiple levels, and where the at least one training program modification was also determined in (c) based on the particular level; and/or
The method where the at least one training program modification changes the user to a different level. Implementations of the described techniques may include hardware, a method or process, or computer software on a computer-accessible medium.

Another general aspect includes a computer-implemented, including (a) obtaining a training program from a remote system. The method also includes (b) running the training program for a user wearing a virtual reality (VR) headset, and (c) presenting video images in a display of the VR headset corresponding to actions of the user. The method also includes (d) determining movement data corresponding to movements of the user; and (e) providing at least some of the movement data to the remote system. The method also includes (f) obtaining a modified training program from the remote system, where the modified training program was determined by the remote system based on the movement data.

Other embodiments of this aspect include corresponding computer systems, apparatus, and computer programs recorded on one or more computer storage devices, each configured to perform the actions of the methods.

Implementations may include one or more of the following features, alone or in combination(s):
The method where, in (c), the movement data are determined, at least in part, by the VR headset; and/or
The method where the VR headset provides the movement data to the remote system in (e) via a distributed network; and/or
The method where the VR headset obtains the training program in (a) and the modified training program in (f) from the remote system via a distributed network; and/or
The method where modifying of the training program dynamically adjusts a level of difficultly of the training program; and/or
The method where the modified training program was determined by the remote system based on a comparison of the movement data to expected or desired movements of the user; and/or
The method where physiological data of the user are provided to the remote system, and where the modified training program was determined by the remote system based also on the physiological data of the user; and/or
The method where the modified training program was also determined by the remote system based on goals or targets set for the user; and/or
The method where the training program produces a user score, and where the user score is provided to the remote system, and where the modified training program was also determined by the remote system based on the user score; and/or
The method where the training program has multiple levels, and where the user is at a particular level of the multiple levels, and where the particular level is provided to the remote system, and where the modified training program was also determined by the remote system based on the particular level; and/or
The method where the modified training program changes the user to a different level; and/or
The method where the modified training program was also determined by the remote system based on prior data about the user. The prior data about the user may include: prior movement data of the user and/or prior training programs or activities of the user; and/or
The method where the training program has multiple levels, and where the modified training program changes a current training level; and/or
The method where the training program has a duration, and where the modified training program changes the duration; and/or
The method where the training program may include multiple parts, and where modified training program changes a current part or an order of the parts; and/or
The method where movement data are determined, at least in part, by the VR headset; and/or
The method where one or more of: (i) determining movement data in (d), (ii) providing at least some of the movement data to a remote system in (e), and (iii) obtaining modified training program in (f), occur in real time.

Implementations of the described techniques may include hardware, a method or process, or computer software on a computer-accessible medium.

Another general aspect includes a computer-implemented including: (a) providing a training routine to a virtual reality (VR) headset, where the training routine may include one or more user activities. The method also includes (b) obtaining movement data from the VR headset, where the movement data corresponds to movement of a user wearing the VR headset, and where the user is performing an activity. The method also includes (c) using at least the movement data to determine whether the movement of the user corresponds to expected or desired movements of the user for the activity. The method also includes (d), based on the using in (c), modifying the training routine to produce a modified training routine when the movement of the user does not correspond to expected or desired movements of the activity. The method also includes (e) providing the modified training routine to the VR headset.

Other embodiments of this aspect include corresponding computer systems, apparatus, and computer programs recorded on one or more computer storage devices, each configured to perform the actions of the methods.

Implementations may include one or more of the following features, alone or in combination(s):
The method where the modified training routine adjusts a level of difficulty of at least one of the one or more user activities; and/or
The method where the training routine may include multiple parts, and where the modified training routine switches to a different part; and/or
The method where the modified training routine is based also on the physiological data of the user; and/or
The method where the physiological data are obtained from the VR headset; and/or
The method where the modified training routine was also determined in (d) based on goals or targets set for the user; and/or
The method where the modified training routine was also determined in (d) based on prior data about the user; and/or
The method where prior data about the user may include: prior movement data of the user and/or prior training programs or activities of the user; and/or
The method where the training routine produces a user score, and where the modified training routine was also determined in (d) based on the user score; and/or
The method where the training routine has multiple levels, and where the user is at a particular level of the multiple levels, and where the modified training routine was also determined in (d) based on the particular level; and/or
The method where the modified training routine changes the user to a different level.

Implementations of the described techniques may include hardware, a method or process, or computer software on a computer-accessible medium.

A skilled reader will understand that any method described above or below and/or claimed and described as a sequence of steps or acts is not restrictive in the sense of the order of steps or acts.

Below is a list of method or process embodiments. Those will be indicated with a letter “P”. Whenever such embodiments are referred to, this will be done by referring to “P” embodiments.
P1. A computer-implemented method comprising:
(A) running a training program for a user wearing a virtual reality (VR) headset;
(B) while running the training program:
   (B)(1) monitoring activity of the user;
   (B)(2) presenting video images in a display of the VR headset corresponding to the activity of the user; and
   (B)(3) based on said monitoring in (B)(1), modifying at least one aspect of said training program.
P2. The method of the preceding embodiment P1, wherein said modifying in (B)(3) occurs in real time.
P3. The method of any of the preceding embodiments, wherein the modifying in (B)(3) is based on one or more of:
(a) a comparison of said activity of the user to expected or desired activity of said user; and/or
(b) physiological data of said user; and/or
(c) goals or targets set by or for said user; and/or
(d) a score achieved by the user during the training program; and/or
(e) a level achieved by the user during the training program; and/or
(f) prior activities of said user.
P4. The method of any of the preceding embodiments, wherein modifying of the training program in (B)(3) dynamically adjusts a level of difficultly of the training program.
P5. The method of any of the preceding embodiments, wherein the training program has multiple levels, and wherein said user is at a particular level of said multiple levels, and wherein modifying of the training program in (B)(3) changes the user to a different level.
P6. The method of any of the preceding embodiments, wherein the training program has a duration, and wherein modifying of the training program in (B)(3) changes the duration.
P7. The method of any of the preceding embodiments, wherein the training program comprises multiple parts, and wherein modifying of the training program in (B)(3) changes a current part or an order of the parts.
P8. The method of any of the preceding embodiments, further comprising, while running the training program in (B):
   (B)(4) determining movement data corresponding to movements of said user;
   (B)(5) providing at least some of said movement data to a remote system; and
   (B)(6) obtaining at least one training program modification from said remote system, wherein said at least one training program modification was determined by said remote system based on said movement data; and then
   (B)(7) based on said at least one training program modification received in (B)(6), modifying a second at least one aspect of said training program.
P9. The method of the preceding embodiment(s) P8, wherein said movement data are determined, at least in part, by said VR headset.
P10. The method of the preceding embodiment(s) P8-P9, wherein the VR headset provides said movement data to the remote system in (E) via a distributed network.
P11. The method of any of the preceding embodiments, wherein modifying of the training program in (B)(7) dynamically adjusts a level of difficultly of the training program.
P12. The method of any of the preceding embodiments, wherein the training program has multiple levels, and wherein said user is at a particular level of said multiple levels, and wherein modifying of the training program in (B)(7) changes the user to a different level.
P13. The method of any of the preceding embodiments, wherein the training program has a duration, and wherein modifying of the training program in (B)(7) changes the duration.
P14. The method of any of the preceding embodiments, wherein the training program comprises multiple parts, and wherein modifying of the training program in (B)(7) changes a current part or an order of the parts.
P15. The method of any of the preceding embodiments, wherein the at least one training program modification was determined by said remote system based on one or more of:
   (i) a comparison of at least some of said movement data to expected and/or desired movements of said user; and/or
   (ii) physiological data of said user, wherein said physiological data was provided to the remote system by said VR headset; and/or
   (iii) goals or targets set for said user; and/or
   (iv) data about one or more prior activities of said user.
P16. The method of any of the preceding embodiment(s) P15, wherein said data about one or more prior activities of said user comprises: prior movement data of said user and/or prior training programs or activities of said user.
P17. A computer-implemented method comprising:
(A) providing a training routine to a virtual reality (VR) headset, wherein said training routine comprises one or more user activities;
(B) obtaining data from the VR headset;
(C) based on said data, determining at least one training program modification for said training routine; and
(D) providing said at least one training program modification to the VR headset.
P18. The method of the preceding embodiment P17, wherein said data obtained in (B) includes movement data corresponding to movement of a user wearing said VR headset, and wherein said user is performing an activity.
P19. The method of any of the preceding embodiments P17-P18, wherein said determining in (C) is based, at least in part, on whether movement of said user corresponds to expected or desired movements of said user for said activity.
P20. The method of any of the preceding embodiments P17-P19, wherein said determining in (C) is based, at least in part, on physiological data of said user.
P21. The method of embodiment(s) P20, wherein the physiological data are obtained from the VR headset.
P22. The method of any of the preceding embodiments P17-P21, wherein said at least one training program modification was also determined in (C) based on goals or targets set for said user.
P23. The method of any of the preceding embodiments P17-P22, wherein said at least one training program modification was also determined in (C) based on prior data about said user.
P24. The method of embodiment(s) P23, wherein said prior data about said user comprises: prior movement data of said user and/or prior training programs or activities of said user.
P25. The method of any of the preceding embodiments P17-P24, wherein the training routine produces a user score, and said at least one training program modification was also determined in (C) based on said user score.
P26. The method of any of the preceding embodiments P17-P25, wherein the training routine has multiple levels, and wherein said user is at a particular level of said multiple levels, and wherein said at least one training program modification was also determined in (C) based on said particular level.
P27. The method of embodiment(s) P26, wherein said at least one training program modification changes the user to a different level.

Below is are device embodiments, indicated with a letter “D”.
D28. A device, comprising:
(a) hardware including memory and at least one processor, and
(b) a service running on the hardware, wherein the service is configured to: perform the method of any of the method embodiments P1-P27.

Below is an article of manufacture embodiment, indicated with a letter “M”.
M29. An article of manufacture comprising non-transitory computer-readable media having computer-readable instructions stored thereon, the computer readable instructions including instructions for implementing a computer-implemented method, the method operable on a device comprising hardware including memory and at least one processor and running a service on the hardware, the method comprising the method of any one of the preceding method embodiments P1-P27.

The above features, along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of a virtual reality fitness/training system according to exemplary embodiments hereof;

FIG. 2 depicts aspects of a user device or headset according to exemplary embodiments hereof;

FIG. 3 depicts aspects of a VR fitness/training system according to exemplary embodiments hereof;

FIGS. 4A-4C are flowcharts of exemplary aspects hereof;

FIG. 5 is a logical depiction of the various feedback loops according to exemplary embodiments hereof; and

FIG. 6 is a logical block diagram depicting aspects of a computer system.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

“AR” means augmented reality.

“VR” means virtual reality.

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

### Description

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

It will be appreciated that variations to the foregoing embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

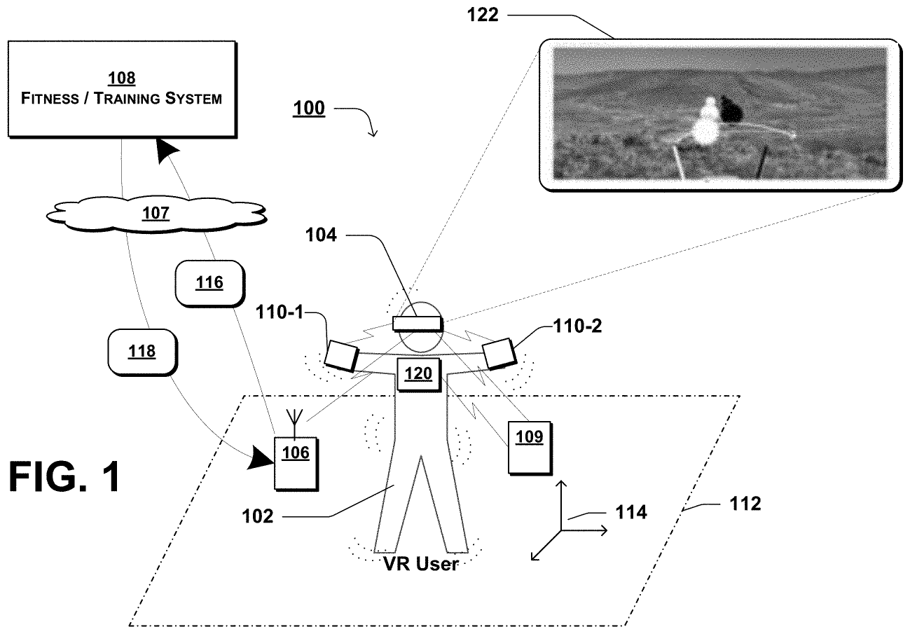

A system supporting a real-time user training virtual reality environment 100 is described now with reference now to FIG. 1, in which a person (VR user) 102 in a real-world environment 112 uses a VR device or headset 104 to view and interact with a virtual environment. The VR headset 104 may be connected (wired and/or wirelessly, e.g., via an access point 106 and network(s) 107) to a fitness/training system 108. Since the user's expected activity may include a lot of movement, the VR headset 104 is preferably wirelessly connected to the fitness/training system 108. In some cases, the headset 104 may have a wired connection to an access point 106 that should be carried by the user 102 to avoid any wires hindering the user's movements.

The network(s) 107 may be local and/or distributed networks, and may include the Internet.

As used herein, the term “activity” may include any activity including, without limitation, any exercise or game, yoga, running, cycling, fencing, tennis, meditation, etc. An activity may or may not require movement, sound (e.g., speech), etc. An activity may include movement (or not) of the user's head, arms, hands, legs, feet, etc. The scope hereof is not limited by the kind of activity.

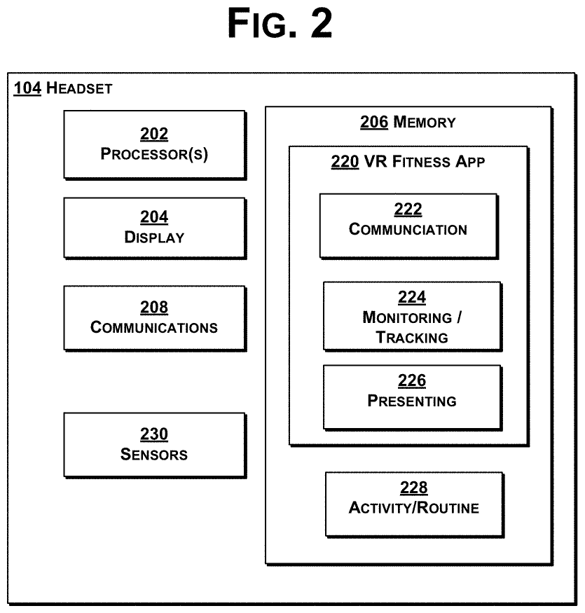

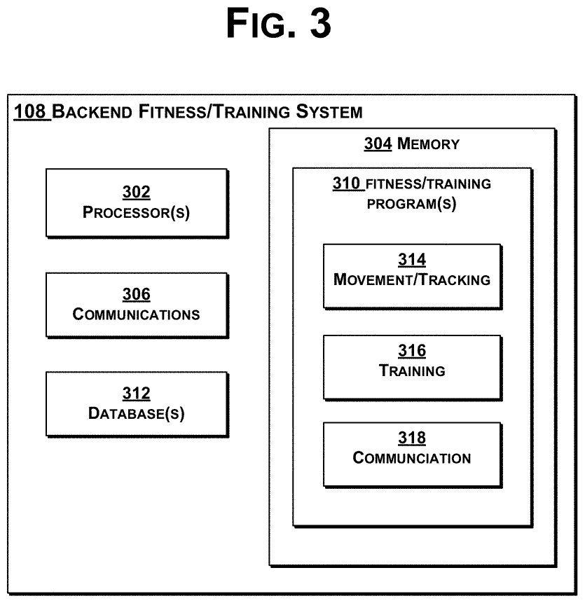

The headset 104 is essentially a computing device (as described below) that may run various programs including a VR fitness application or app (220 in FIG. 2, discussed below) that may connect to a fitness system or fitness/training program(s) (310 in FIG. 3, discussed below) on a fitness/training system 108.

Sensors 230 in the VR headset 104 and/or other sensors (not shown) in the user's environment may track the VR user's actual movements (e.g., head movements, etc.). The VR headset 104 preferably provides user tracking without external sensors. In a presently preferred implementation, the VR headset 104 is an Oculus Quest headset made by Facebook Technologies, LLC.

Data (e.g., including tracking) data from the VR headset 104 may be provided in real-time from the VR fitness application 220 on the headset 104 to the fitness/training program 310 on the fitness/training system 108 (e.g., via the access point 106).

The user 102 may also have one or two handheld devices 110-1, 110-2 (collectively handheld device(s) 110) (e.g., Oculus Touch Controllers). Hand movement information from the handheld device(s) 110 may be provided to the VR fitness application 220 on the VR headset 104 which, in turn may provide the hand movement data to the data to the fitness/training program 310 on the fitness/training system 108 (again, via the access point 106). The handheld devices(s) 110 may communicate wirelessly with the VR headset 104, e.g., using Bluetooth and/or infrared (IR) connections.

The VR fitness application 220 running on the VR headset 104 presents the VR user 102 with a view 122 (on the headset's display 204) corresponding to that VR user's virtual or augmented environment.

Preferably, the view 122 of the VR user's virtual environment is shown as if seen from the location, perspective, and orientation of the VR user 102. The VR user's view 122 may be provided as a VR view or as an augmented view.

The user's headset 104 may be paired with a computing device 109 (e.g., a smartphone or the like) to provide a user interface to the headset 104.

In some embodiments, the user 102 may wear or be connected to one or more physiological sensors 120 (e.g., a heartrate monitor, a temperature sensor, moisture sensors (for sweat levels), breathing monitors, etc.). Data from these physiological sensors 120 may be provided to the headset 104 via the user's computing device 109, and this data may also be provided from the headset 104 to the fitness/training program 310 on the fitness/training system 108.

For example, a user may wear a heartrate monitor to provide heartrate data while a microphone on the user's computing device may be used to track the sound of the user's breathing (as a proxy measure of exertion).

Although shown as connecting to the backend via an access point 106, the headset may connect in other ways that provide network (and preferably Internet) access.

Headsets

With reference now to FIG. 2, aspects of a headset 104 are described according to exemplary embodiments hereof.

A headset 104 may include one or more processors 202, display 204, and memory 206. Various programs (including, e.g., the device's operating system as well as so-called applications or apps) may be stored in the memory 206 for execution by the processor(s) 202 on the headset 104. The memory may include random access memory (RAM), caches, read-only storage (e.g., ROMs, etc.). As should be appreciated, the headset 104 is essentially a computing device (described in greater detail below).

The headset 104 preferably includes one or more communications mechanisms 208, supporting, e.g., WiFi, Bluetooth and other communications protocols. In this manner, as is known, the device may communicate with other devices via one or more networks (e.g., via the Internet, a LAN, a WAN, a cellular network, a satellite connection, etc.).

In some exemplary embodiments, devices may communicate directly with each other, e.g., using an RF (radio frequency) protocol such as WiFi, Bluetooth, Zigbee, or the like.

The headset 104 may include other components (e.g., cameras, microphones, etc.) that are not shown in the drawing.

As depicted in FIG. 2, the headset 104 may include a VR fitness mechanism that may be or comprise a VR fitness app 220 that may be loaded into the memory 206 of the headset 104 and may run by the processor(s) 202 and other components of headset 104.

An exemplary VR fitness app 220 may include one or more of the following mechanisms:
1. Communication mechanism(s) 222
2. Monitoring/tracking mechanism(s) 224
3. Presenting mechanism(s) 226

This list of mechanisms is exemplary, and is not intended to limit the scope of the invention in any way. Those of ordinary skill in the art will appreciate and understand, upon reading this description, that the VR fitness app 220 may include any other types of mechanisms, and/or general or other capabilities that may be required for the VR fitness app 220 to generally perform its functionalities as described in this specification. In addition, as should be appreciated, embodiments or implementations of the VR fitness app 220 need not include all of the mechanisms listed, and that some or all of the mechanisms may be optional.

The mechanisms are enumerated above to provide a logical description herein. Those of ordinary skill in the art will appreciate and understand, upon reading this description, that different and/or other logical organizations of the mechanisms may be used and are contemplated herein. It should also be appreciated that, while shown as separate mechanisms, various of the mechanisms may be implemented together (e.g., in the same hardware and/or software). As should also be appreciated, the drawing in FIG. 2 shows a logical view of exemplary aspects of the device, omitting connections between the components.

In operation, the VR fitness app 220 may use each mechanism individually or in combination with other mechanisms. When not in use, a particular mechanism may remain idle until such time its functionality may be required by the VR fitness app 220. Then, when the VR fitness app 220 may require its functionality, the VR fitness app 220 may engage or invoke the mechanism accordingly.

The VR fitness app 220 may present the user 102 with an activity or exercise routine for the user to perform. The activity or routine may be stored in the memory 206, e.g., as activity/routine 228. The activity/routine 228 may be provided to the headset 104 by the fitness/training system 108, as described below.

The monitoring/tracking mechanism(s) 224 of the VR fitness app 220 may monitor and/or track the user's performance of the activity/routine, and may modify aspects thereof, preferably in real-time, based on the manner in which the user is performing the activity. For example, the activity may comprise a game in which the user has to virtually hit objects in a virtual space. The objects may appear in the virtual space at certain locations and at a certain rate. The monitoring/tracking mechanism(s) 224 may monitor the user's hit rate and may adjust the rate and/or locations at which the objects appear in the virtual space. For example, if the user keeps missing objects then the monitoring/tracking mechanism(s) 224 may adjust the activity to have objects appear at a lower rate and/or closer to each other. On the other hand, if the user seldom misses an object, then the monitoring/tracking mechanism(s) 224 may adjust the activity to make it harder (e.g., by making objects appear at a higher rate and/or faster and/or in a wider area).

The VR fitness app 220 this includes a real-time feedback system that may modify a user's activity based on how the user is performing.

In addition (or instead), the fitness/training system 108 may also make changes to the activity/routine 228. Changes made by the fitness/training system 108 may also be based on the user's activity, and may be reflected by the VR fitness app 220 running on the headset 104.

Those of skill in the art will understand, upon reading this description, that the nature of certain activities (e.g., fast moving games) will require feedback in real time from the local tracking mechanism(s) 224 of the VR fitness app 220. Communication delays (from the headset 104 to the fitness/training system 108 and back) are likely too large to provide certain kinds of feedback. For example, if the VR fitness app 220 is presenting a fast-playing game that needs to be adjusted every few seconds, such adjustments should probably be made in real time by a routine running on the headset 104. On the other hand, when real time feedback is not needed, it may be acceptable to have the feedback determined and provided by the fitness/training system 108. For example, a user's overall progress in a series of activities may suitably be evaluated by the fitness/training system 108, which may then provide modification of the user's activities.

The Backend Fitness/Training System

With reference to FIG. 3, the fitness/training system 108 is a computer system (as discussed below), with processor(s) 302, memory 304, communication mechanisms 306, etc. One or more fitness/training programs 310 run on the fitness/training system 108. The fitness/training program(s) 310 may store data in and retrieve data from one or more databases 312.

Although only one user 102 is shown in FIG. 1, it should be appreciated that the fitness/training system 108 may interact with multiple users at the same time. It should also be appreciated that the following description of the operation of the fitness/training system 108 with one user extends to multiple users.

The fitness/training programs 310 may include movement/tracking mechanism(s) 314, training mechanism(s) 316, and communication mechanism(s) 318.

In operation, the fitness/training programs 310 provide the user's headset 104 with an activity/routine 118 (which may be stored as activity/routine 228 in the memory 206 of the headset 104). As noted, the VR fitness app 220 on the headset 104 may use the activity/routine 228 to present a VR/AR interaction with the user.

The movement/tracking mechanism(s) 314 may receive user data 116 from a connected VR headset 104 and may determine and/or approximate, from that data, the user's actual movements in the user's real-world space/environment 112. The user's movements may be given relative to a 3-D coordinate system 114 the user's real-world space 112. If the user also has handheld devices 110, the movement/tracking mechanism(s) 314 may also determine movement of one or both of the user's hands in the user's real-world space 112. In some cases, the user's headset 104 may provide the user's actual 3-D coordinates in the real-world space 112 to the fitness/training programs 310 on the fitness/training system 108.

The movement/tracking mechanism(s) 314 may determine or extrapolate aspects of the user's movement based on machine learning (ML) or other models of user movement. For example, a machine learning mechanism may be trained to recognize certain movements and/or types of movements and may then be used to recognize those movements based on the data provided by the user's headset 104.

The training mechanism(s) 316 may evaluate the user's movements (as determined by the movement/tracking mechanism(s) 314), and, may compare the user's movements to expected and/or desired movements for the activity that the user is supposed to be performing. That is, having determined what the user is doing (e.g., how the user is moving) from the data provided by the user's headset 104, the training mechanism(s) 316 may determine how much the user's movements differ or deviate from expected or desired movements.

An amount of difference or deviation of the user's actual movements from the expected and/or desired movements may be used by the training mechanism(s) 316 to suggest or apply one or more modifications to the user's current and/or future activities. The modifications for a particular user may be based on various factors, including that user's prior activities, known abilities as well as goals and targets set by the user (or a trainer). In some cases the user activity may include a game or other activity in which the user may achieve a score or one or more goals in the game. In such cases, the user's score and/or goals achieved in the game may be provided to the fitness/training system 108, and these scores and/or goals achieved may be used to modify the user's current activities. For example, if a user is having difficulty achieving an expected score in a game, the game's difficulty level may be adjusted.

In some embodiments, the fitness/training system 108 may also receive physiological data from the user's headset 104 and may use some of the physiological data (e.g., heartrate, temperature, sweat level, perspiration rate, breathing rate, etc.) to determine one or more modifications.

Modifications to the user's routine may be used by the backend to dynamically adjust or modify the user's current and/or future activity. Such modifications or adjustments may be reflected in the activity/routine 118 sent from the fitness/training system 108 to the user's VR fitness app 220 on the user's headset 104.

Modification of the user's activity may include, without limitation, increasing or decreasing a degree of difficulty of the activity, changing the duration of components of the user's activity, or switching the user's activity to a different (harder or easier or just different) activity.

In some cases, the user may be participating in a series of activities, in which case the modification may include moving forward (or backward) in that series of activities. For example, if the system determines that a user has not yet learned a basic movement, the modification may be to initiate a tutorial or training activity. As another example, if the system determines that the user's movements are degrading and the user's heart rate is very high, the modification may be to move to a cool down or rest phase.

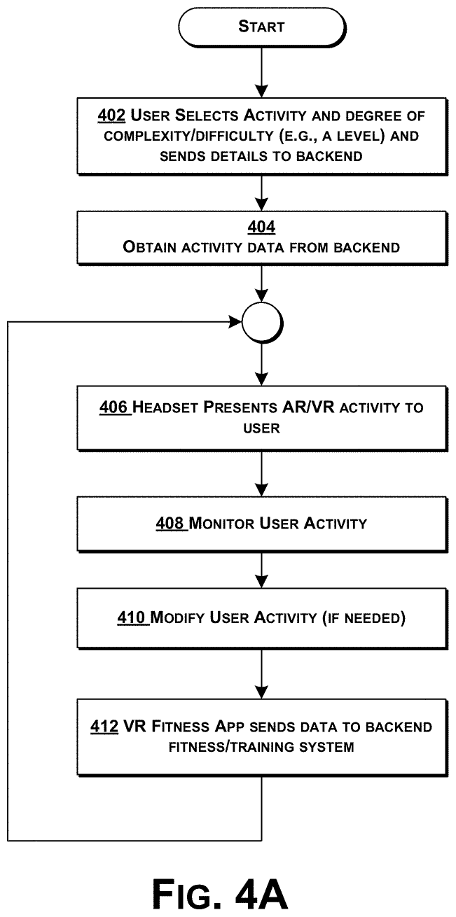

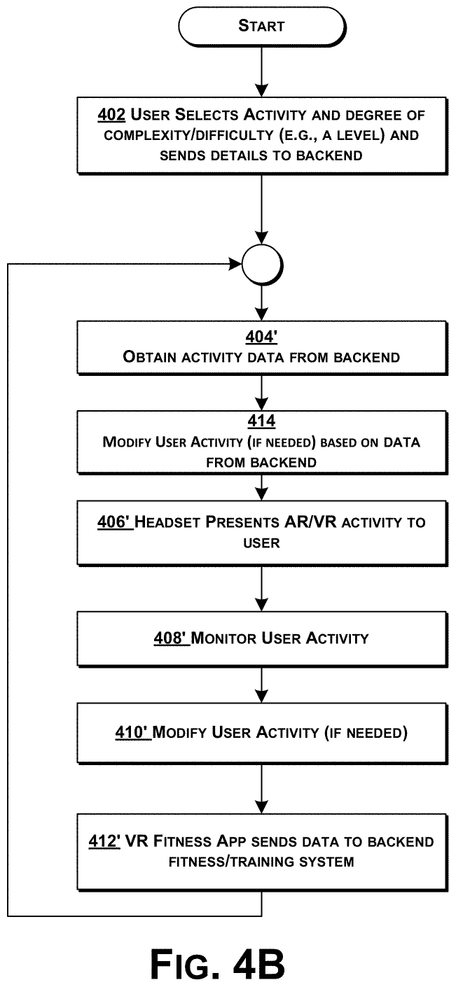

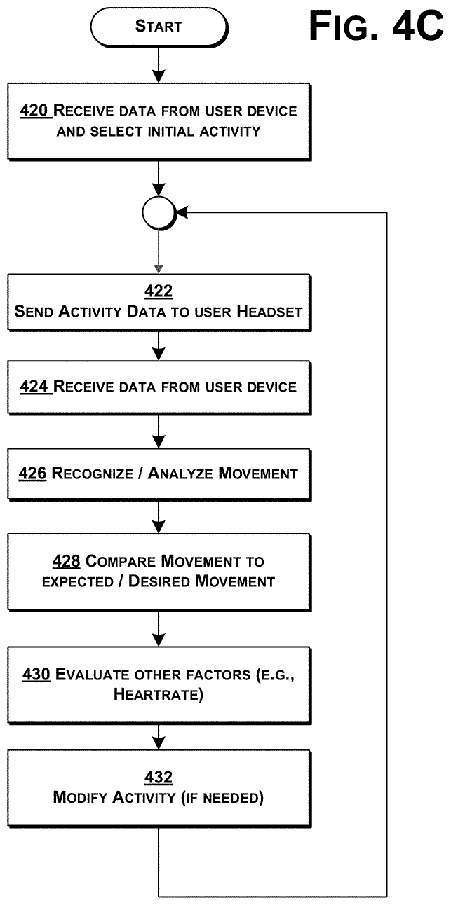

FIGS. 4A and 4B are flowcharts of exemplary aspects hereof, with FIG. 4A showing activity on the user side or client side (e.g., by the user and headset 104, including VR fitness app 220), and FIG. 4B showing activity by the fitness/training system 108, including fitness/training programs 310.

The examples described here excludes the setup of the device and linking the headset to the user device and the user device to the backend. These may be done in any suitable manner and may depend on the kind of headset, device, network connections, etc. For the sake of this example description, it may be assumed that the user's headset is connected to their device, and that the device is connected to the backend.

As shown in FIG. 4A, a user uses the VR fitness app 220 to select a routine (e.g., an exercise routine or game or the like) (at 402). The VR fitness app 220 may ask the user to select a degree of difficulty or complexity or may be based the initial degree of difficulty and/or complexity on the user's previous activities (at 402). The VR fitness app 220 may communicate with the backend to determine starting parameters and actions for the user's activity (at 402).

The fitness/training programs 310 on the fitness/training system 108 may select a user activity/routine based on the user's choices and sends instructions for that activity/routine (as activity/routine 118) to the headset 104.

The headset 104 may obtain activity/routine 118 from the fitness/training system 108 (at 404). The fitness/training system 108 may provide start parameters for the selected activity, based, e.g., on the user's prior activities and performance with that activity.

The selected activity may be stored as activity/routine 228 and may be run by VR fitness app 220 on the headset 104 (at 406). The presenting mechanism(s) 226 of the VR fitness app 220 present the selected activity to the user as an AR/VR experience, based on the activity/routine 118.

The user begins (or continues) their activity, and the monitoring/tracking mechanism(s) 224 of the headset 104 track/monitor the activity and the user's performance (at 408).

The VR fitness App 220 may modify the user's activity, if needed (at 410). The modification may be based, e.g., on the monitoring/tracking performed by the tracking mechanism(s) 224.

The headset 104 (and handheld devices 110, if used) may provide (at 412) some or all of the user's movement data and possibly other data to the fitness/training system 108.

The VR fitness app 220 repeats the process (at 406, 408, 410, 412) until the user is done with the activity or the activity ends.

In the example flow shown in FIG. 4A, data sent to the backend (at 412) may affect subsequent user activities. In another exemplary flow, as shown in FIG. 4B, the VR fitness app 220 obtains activity data from the backend (at 404′) and may then modify the user activity (at 414), if needed, based on the data received from backend (at 404′). The VR fitness App 220 then presents the AR/VR activity to the user (at 406′), monitors the user's activity (at 408′) and may modify the user activity (at 410′), if needed. Data are then sent to the fitness/training system 108 (at 412′).

In the example flow of FIG. 4B, the VR fitness app 220 repeats the process (at 404′, 414, 406′, 408′, 410′, 412′) until the user is done with the activity or the activity ends.

Note that in this second exemplary flow (in FIG. 4B), the user activity may be modified twice, at 414, based on data received from the fitness/training system 108 and/or at 410′, based on the monitoring done by the headset at 408′. Those of skill in the art will understand, upon reading this description, that inherent network and communication delays mean that the modifications (at 414) based on the data sent from the fitness/training system 108 may not provide a real-time response to the user's activities (the feedback loop is from the headset 104 to the fitness/training system 108 and then back to the headset). On the other hand, the modifications (at 410′) may provide a sufficiently real-time response to the user's activities (at the feedback loop is local to the headset 104).

The example flow of FIG. 4B thus allows the VR fitness app 220 to modify the user's current activity based on feedback from the fitness/training system 108 and/or local feedback.

As should be appreciated, in any particular use of the VR fitness app 220, depending, e.g., on the user's activity and performance, there may be no modifications or multiple modifications made. Further, for any particular use, there may be modifications at the local level (i.e., at 410′ based on local feedback) and/or at the global level (i.e., at 414, based on feedback from the fitness/training system 108).

Those of skill in the art will understand, upon reading this description, that the local modifications (i.e., at 410′ based on local feedback) more likely relate to the user's current and immediate performance, whereas the global level modifications (i.e., at 414, based on feedback from the fitness/training system 108) may relate to the user's overall performance and goals. For example, a local modification may change the speed at which objects appear in a game, whereas a global modification may change to a different activity (e.g., from one of a series of activities to another).

The flowchart in FIG. 4C shows aspects of operation of the fitness/training programs 310 on the fitness/training system 108. The fitness/training programs 310 receives information (at 420) from the headset 104 (sent at 402, FIG. 4A), and, based on the information received from the headset 104, the fitness/training programs 310 selects an activity for the user.

The fitness/training programs 310 sends activity/routine data (118 in FIG. 1) to the headset 104 (at 422).

The fitness/training programs 310 receives data from the headset 104 (at 424, corresponding to the user data 116 in FIG. 1) sent by the headset 104 (at 408 in FIG. 4A). While the activity is going on at the user's end, and the user's headset 104 is operating as described above with respect to FIG. 3A, the fitness/training program(s) 310 on the fitness/training system 108 continuously receive user data 116 (which includes user movement or telemetry data) from the user device (at 420).

The fitness/training programs 310 analyzes those data (at 426) to try to recognize and analyze the user's movement. The programs 310 then try to determine (at 428) whether and by how much the user's movements or activity deviates from the expected/desired activity. The fitness/training program(s) 310 may also (at 430) determine or evaluate other factors (e.g., the user's heartrate, goals, prior activities, etc.)

Based on deviation of the user's activity/movements from those expected or desired (determined at 428), as well, possibly, as other factors (determined at 430), the fitness/training program(s) 310 determines (at 432) whether modification to the user's current activities is needed, and, if so, modifies the activities.

Any modification to the user's activity/routine 118 may be sent to the user's headset 104 (at 422).

The fitness/training program(s) 310 repeats acts 422, 424, 426, 428, 430, 432 until the activity ends or the user stops interacting.

As should be appreciated, the VR fitness app 220 on the user's headset 104 and the fitness/training program(s) 310 on the backend may need to be synchronized. The VR fitness app 220 provides a continuous stream of user movement data (and possibly physiological data) as user data 116 to the fitness/training program(s) 310. On the fitness/training system 108 the user data 116 may be continuously received and processed by the fitness/training program(s) 310 (as described above). When needed (as determined by the backend), the user's activity may be modified by the backend and the activity data sent to the headset 104 will reflect such modification.

The feedback loop described above may be repeated for the duration of the user's activity with the VR fitness app 220.

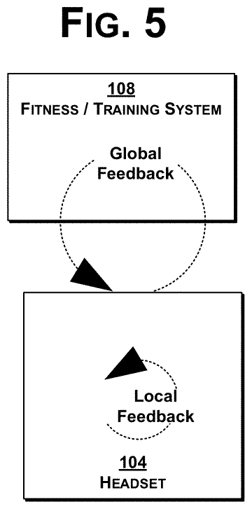

The diagram in FIG. 5 summarizes the global and local feedback loops between a fitness/training system 108 and a particular headset 104.

The feedback loop described above may be ongoing for multiple users simultaneously.

As noted above, the user's headset 104 may be paired with a user's computing device 109 (e.g., a smartphone or the like) to provide a user interface to the headset 104. For example, a user's phone may be used to setup the device and to make some of the initial selections (e.g., at 402 in FIG. 4A). The mobile device may also be used to connect one or more physiological sensors 120 (e.g., heartrate monitors) with the headset 104. In this manner, the headset may obtain physiological data from the physiological sensors 120 via the mobile device. An advantage of this approach is that the headset 104 does not need to know how to interact with multiple types of physiological sensors 120, as that task is left to the mobile device.

### Examples

A system is provided using an Oculus Quest headset connected to and synched with an Android device. The user is also provided with handheld devices (e.g., Android).

The headset and a mobile device (Android) are paired to establish a connection between the mobile device and headset so that a user's workout activity can be pushed from the headset to the mobile device.

In some implementations the user may be required to enter authentication information (e.g., a PIN code or the like).

If the user has a heartrate monitor (e.g., watch, chest strap, or the like), that monitor may be connected to the mobile device and/or to the headset so that a user's heart rate activity may be presented by the headset.

As an initial step, the user is provided with a tutorial on how to use the system. The user may be asked to do some simple movements such as wave their hands, squat, lunge, turn, etc. They may also be asked to virtual touch or interact with objects in a virtual world. In this way the user may become accustomed to the VR environment and the system may calibrate to the user's movements, size, shape, etc.

In a current implementation, calibration determines a user's height and wingspan (arm span) to understand the ideal placement of virtual objects relative to that user's specific proportions.

If the system cannot determine an accurate wingspan from a user, or if the wingspan differs substantially with the headset height, the system may assume that the headset height is equivalent to the wingspan.

Essentially the tutorial provides a simple workout for the user, while familiarizing them with the VR device and environment.

Having paired and synchronized the devices (mobile device and headset), taken the tutorial, and calibrated the devices, a user may use the system for workouts.

The user may be presented with a workout home screen (on the display of the mobile device or on the VR headset's display) from which the user may select a workout or activity. From that screen, the user may select a particular workout.

A workout may include multiple stages or parts, including a warmup and a cool down and one or more stages in between. The stages may include games or other activities in which the user interacts with virtual objects in a virtual world. The stages may have difficulty levels and the user's activities in a stage (or for the whole workout) may be scored.

While the user is performing their activities, their headset sends information about their movement to a system that compares the user's movements to those expected/desired for that activity or workout. The system may then adjust the difficulty level based on real-time user performance during a workout. As should be appreciated, this allows a user to scale their play to their current performance level.

For one particular VR game, users are assessed dynamically during gameplay. In this case, there are four levels of difficulty that adjust based off the following criteria:

In an additive mode, successes and failures are tracked by the same tracker. Successes add to the tracker, and failures subtract from it. The failure threshold is always zero, but the success threshold is configurable. Reaching a threshold moves the player up or down a difficulty level, and then resets the tracker to half of the success threshold. Additionally, weights may be added to the value of hitting or missing, such that hitting a target may be worth 1, whereas missing may cost 2 or 3. A success is defined as a target hit in the intended direction at the correct moment with the right virtual sword. A failure is defined as a missed target, a target hit in the wrong direction, or a target hit with the wrong virtual sword.

For example, if a success threshold is 20, when the player hits the next 10 targets, they move up a level of difficulty. The tracker is reset to 10. If they miss 9 of the next 10 targets, which sets their success tracker to 1. They hit the same number of targets as they miss for the next several measures of the song, keeping them on the same difficulty level.

One of the activities or stages or phases of a collection of activities may be meditation. A meditation experience preferably occurs after a cool down phase.

Once a workout is concluded, the user is taken to a summary screen of data that indicates their performance.

### Example

In another example, the decision whether to adjust difficulty level is made on the client (headset), using short term historical data locally cached (e.g., how many targets has the user hit in succession). In some implementations, this adjustment uses an algorithm which has its control parameters set by values supplied by a server at the start of a session.

### Real Time

As should be appreciated, the feedback loop described (from VR headset to AR fitness app and then back to the VR headset) occurs in real time.

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time computation may refer to an online computation, i.e., a computation that produces its answer(s) as data arrive, and generally keeps up with continuously arriving data. The term “online” computation is compared to an “offline” or “batch” computation.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

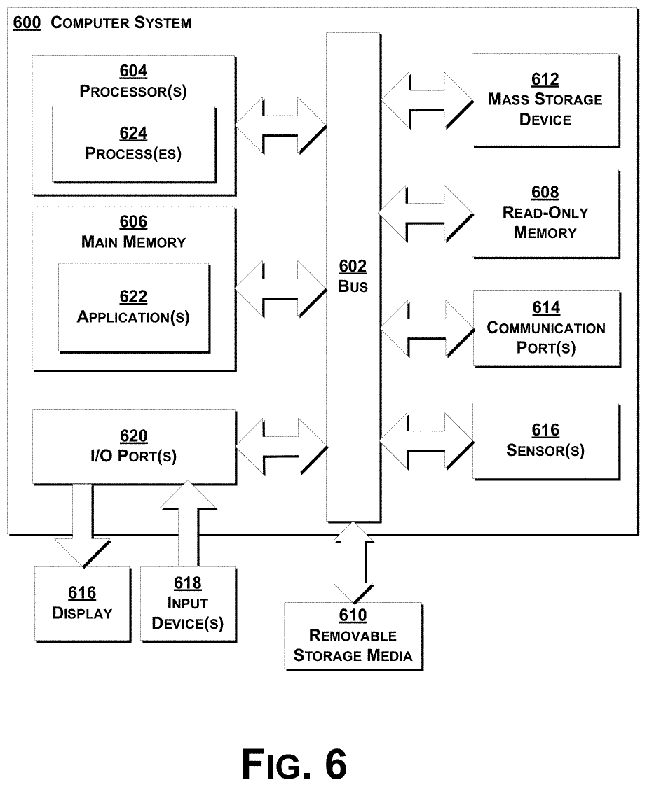

FIG. 6 is a schematic diagram of a computer system 600 upon which embodiments of the present disclosure may be implemented and carried out.

According to the present example, the computer system 600 includes a bus 602 (i.e., interconnect), one or more processors 604, a main memory 606, read-only memory 608, removable storage media 610, mass storage 612, and one or more communications ports 614. Communication port(s) 614 may be connected to one or more networks (not shown) by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an Ethernet port, a Gigabit port using copper or fiber, or a USB port, and the like. Communications port(s) 614 may be chosen depending on a network such as a Local Area Network (LAN), a Wide Area Network (WAN), or any network to which the computer system 600 connects. The computer system 600 may be in communication with peripheral devices (e.g., display screen 616, input device(s) 618) via Input/Output (I/O) port 620.

Main memory 606 can be Random Access Memory (RAM), or any other dynamic storage device(s) commonly known in the art. Read-only memory (ROM) 608 can be any static storage device(s) such as Programmable Read-Only Memory (PROM) chips for storing static information such as instructions for processor(s) 604. Mass storage 612 can be used to store information and instructions. For example, hard disk drives, an optical disc, an array of disks such as Redundant Array of Independent Disks (RAID), or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 606 is encoded with application(s) 622 that support(s) the functionality as discussed herein (the application(s) 622 may be an application(s) that provides some or all of the functionality of the services/mechanisms described herein). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service related to the application(s). In other words, the process(es) 624 represent one or more portions of the application(s) 622 performing within or upon the processor(s) 604 in the computer system 600.

For example, process(es) 624 may include an AR application process corresponding to VR fitness application 220 or the fitness/training program(s) 310.

It should be noted that, in addition to the process(es) 624 that carries(carry) out operations as discussed herein, other embodiments herein include the application(s) 622 itself (i.e., the un-executed or non-performing logic instructions and/or data). The application(s) 622 may be stored on a computer readable medium (e.g., a repository) such as a disk or in an optical medium. According to other embodiments, the application(s) 622 can also be stored in a memory type system such as in firmware, read only memory (ROM), or, as in this example, as executable code within the main memory 606 (e.g., within Random Access Memory or RAM). For example, application(s) 622 may also be stored in removable storage media 610, read-only memory 608, and/or mass storage device 612.

Those skilled in the art will understand that the computer system 600 can include other processes and/or software and hardware components, such as an operating system that controls allocation and use of hardware resources.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs”, and includes the case of only one ABC.

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

Thus is provided an augmented reality system that combines a live view of a real-world, physical environment with imagery based on live images from one or more other devices.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A computer-implemented method comprising:
(A) running a training program for a user wearing a virtual reality (VR) headset;
(B) while running the training program:
(B)(1) monitoring activity of the user;
(B)(2) presenting video images in a display of the VR headset corresponding to the activity of the user; and
(B)(3) based on said monitoring in (B)(1), modifying at least one aspect of said training program.

2. The method of claim 1, wherein said modifying in (B)(3) occurs in real time.

3. The method of claim 1, wherein the modifying in (B)(3) is based on one or more of:
(a) a comparison of said activity of the user to expected or desired activity of said user; and/or
(b) physiological data of said user; and/or
(c) goals or targets set by or for said user; and/or
(d) a score achieved by the user during the training program; and/or
(e) a level achieved by the user during the training program; and/or
(f) prior activities of said user.

4. The method of claim 1, wherein modifying of the training program in (B)(3) dynamically adjusts a level of difficultly of the training program.

5. The method of claim 1, wherein the training program has multiple levels, and wherein said user is at a particular level of said multiple levels, and wherein modifying of the training program in (B)(3) changes the user to a different level.

6. The method of claim 1, wherein the training program has a duration, and wherein modifying of the training program in (B)(3) changes the duration.

7. The method of claim 1, wherein the training program comprises multiple parts, and wherein modifying of the training program in (B)(3) changes a current part or an order of the parts.

8. The method of claim 1, further comprising, while running the training program in (B):
(B)(4) determining movement data corresponding to movements of said user;
(B)(5) providing at least some of said movement data to a remote system; and
(B)(6) obtaining at least one training program modification from said remote system, wherein said at least one training program modification was determined by said remote system based on said movement data; and then
(B)(7) based on said at least one training program modification received in (B)(6), modifying a second at least one aspect of said training program.

9. The method of claim 8, wherein said movement data are determined, at least in part, by said VR headset.

10. The method of claim 8, wherein the VR headset provides said movement data to the remote system in (E) via a distributed network.

11. The method of claim 8, wherein modifying of the training program in (B)(7) dynamically adjusts a level of difficultly of the training program.

12. The method of claim 8, wherein the training program has multiple levels, and wherein said user is at a particular level of said multiple levels, and wherein modifying of the training program in (B)(7) changes the user to a different level.

13. The method of claim 8, wherein the training program has a duration, and wherein modifying of the training program in (B)(7) changes the duration.

14. The method of claim 8, wherein the training program comprises multiple parts, and wherein modifying of the training program in (B)(7) changes a current part or an order of the parts.

15. The method of claim 8, wherein the at least one training program modification was determined by said remote system based on one or more of:
(i) a comparison of at least some of said movement data to expected and/or desired movements of said user; and/or
(ii) physiological data of said user, wherein said physiological data was provided to the remote system by said VR headset; and/or
(iii) goals or targets set for said user; and/or
(iv) data about one or more prior activities of said user.

16. The method of claim 15, wherein said data about one or more prior activities of said user comprises: prior movement data of said user and/or prior training programs or activities of said user.

17. A computer-implemented method comprising:
(A) providing a training routine to a virtual reality (VR) headset, wherein said training routine comprises one or more user activities;
(B) obtaining data from the VR headset;
(C) based on said data, determining at least one training program modification for said training routine; and
(D) providing said at least one training program modification to the VR headset.

18. The method of claim 17, wherein said data obtained in (B) includes movement data corresponding to movement of a user wearing said VR headset, and wherein said user is performing an activity.

19. The method of claim 17, wherein said determining in (C) is based, at least in part, on whether movement of said user corresponds to expected or desired movements of said user for said activity.

20. The method of claim 17, wherein said determining in (C) is based, at least in part, on physiological data of said user.

21. The method of claim 20, wherein the physiological data are obtained from the VR headset.

22. The method of claim 17, wherein said at least one training program modification was also determined in (C) based on goals or targets set for said user.

23. The method of claim 17, wherein said at least one training program modification was also determined in (C) based on prior data about said user.

24. The method of claim 23, wherein said prior data about said user comprises: prior movement data of said user and/or prior training programs or activities of said user.

25. The method of claim 17, wherein the training routine produces a user score, and said at least one training program modification was also determined in (C) based on said user score.

26. The method of claim 17, wherein the training routine has multiple levels, and wherein said user is at a particular level of said multiple levels, and wherein said at least one training program modification was also determined in (C) based on said particular level.

27. The method of claim 17, wherein said at least one training program modification changes the user to a different level.
